(19) United States
(12) Patent Application Publication
(10) Pub. No.: US 2010/0005921 A1
(43) Pub. Date: Jan. 14, 2010

(54) CONTROL CABLE ADJUSTER

(75) Inventors: Paul Thomas, Waukesha, WI (US); Scott L. Hurwitz, Rochester, NY (US)

Correspondence Address: MICHAEL BEST & FRIEDRICH LLP, 100 E WISCONSIN AVENUE, Suite 3300, MILWAUKEE, WI, 53202, US

(73) Assignees: Harley-Davidson Motor Company Group, Inc., Milwaukee, WI (US); Magnum Sheilding Corporation, Pittsford, NY (US)

(21) Appl. No.: 12/171,809

(22) Filed: Jul. 11, 2008

(51) Int. Cl. F16C 1/22

(52) U.S. Cl. 74/502.6; 180/219; 188/2 D

(57) ABSTRACT

A control cable adjuster including a first adjusting element with a first engagement portion, a second adjusting element with a second engagement portion coupled to the first engagement portion, and a rigid cover removably coupled to at least one of the first adjusting element and the second adjusting element. The second adjusting element configured for adjustable axial movement relative to the first adjusting element while maintaining the first and second engagement portions coupled together. The rigid cover is movable between a covered position where the rigid cover substantially covers a portion of the first engagement portion, and an exposed position where the rigid cover substantially exposes a portion of the first engagement portion.

### BACKGROUND

The present invention relates to control cables and control cable management.

Control cables are often utilized on vehicles such as motorcycles where remote control of components is desirable. For example, a user may pull a remote clutch lever to actuate a clutch via the control cable.

### SUMMARY

In one embodiment, the invention provides a control cable adjuster that includes a first adjusting element with a first engagement portion, a second adjusting element with a second engagement portion coupled to the first engagement portion, and a rigid cover removably coupled to at least one of the first adjusting element and the second adjusting element. The second adjusting element is configured for adjustable axial movement relative to the first adjusting element while maintaining the first and second engagement portions coupled together. The rigid cover is movable between a covered position where the rigid cover substantially covers a portion of the first engagement portion, and an exposed position where the rigid cover substantially exposes a portion of the first engagement portion.

In another embodiment the invention provides a motorcycle that includes a user operable interface, a component associated with the user operable interface, a control cable connected between the user operable interface and the component and including a control cable adjuster.

In another embodiment the invention provides a method of adjusting a control cable adjuster. The method includes coupling a first engagement portion of a first adjusting element with a second engagement portion of a second adjusting element, moving the first adjusting element axially with respect to the second adjusting element, coupling a rigid cover with at least one of the first adjusting element and the second adjusting element, substantially covering the first engagement portion with the rigid cover when the rigid cover is in a covered position, uncoupling the rigid cover from at least one of the first adjusting element and the second adjusting element, moving the rigid cover between the covered position and the exposed position, and substantially exposing the first engagement portion with the rigid cover when the rigid cover is in an exposed position.

Other aspects of the invention will become apparent by, consideration of the detailed description and accompanying drawings.

### BRIEF DESCRIPTION OF THE DRAWINGS

FIG. 1 is a side view of a motorcycle.

FIG. 2 is a perspective view of a control cable that includes a control cable adjuster according to one embodiment of the invention.

FIG. 3 is an exploded view of the control cable adjuster shown in FIG. 2.

FIG. 4 is a perspective view of the control cable adjuster shown in FIG. 2 with a cover in an exposed position and adjusted to a first length.

FIG. 5 is a perspective view of the control cable adjuster shown in FIG. 4 with the cover in a covered position.

FIG. 6 is a perspective view of the control cable adjuster shown in FIG. 2 with the cover in the exposed position and adjusted to a second length.

FIG. 7 is a perspective view of the control cable adjuster shown in FIG. 6 with the cover in the covered position.

FIG. 8 is a cross section view of the control cable adjuster taken along line 8-8 of FIG. 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

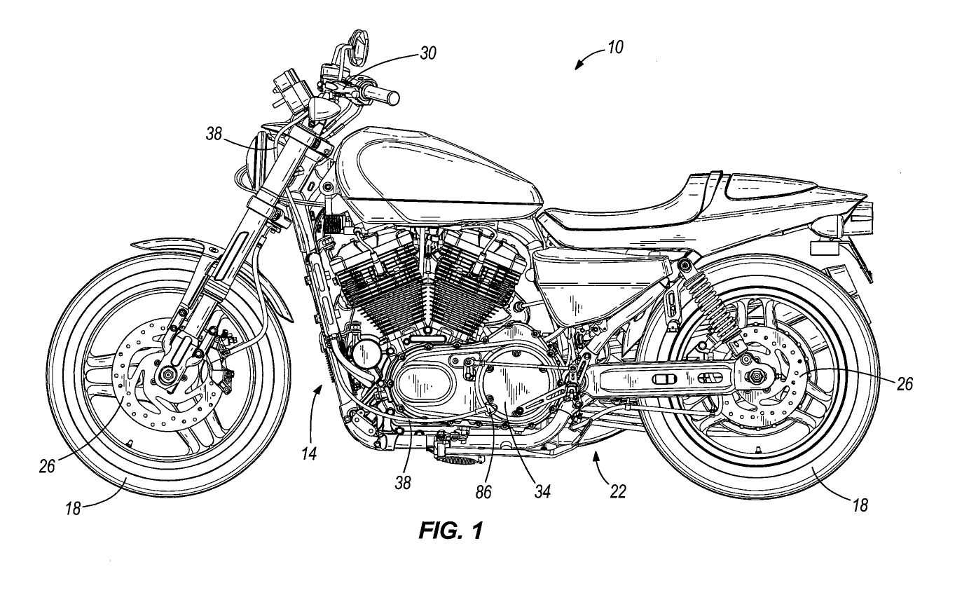

FIG. 1 shows a motorcycle 10 that includes an engine 14, two wheels 18, a drive train 22, brake disks 26, a user operable interface in the form of a clutch lever assembly 30, a component in the form of a clutch (not shown) within a clutch housing 34, and a control cable assembly 38 connecting the clutch lever assembly 30 and the clutch housing 34. Other user operable interfaces may include a brake lever, a throttle grip, a shifter, or another interface that may be used by a user to perform an action on the motorcycle. Likewise, other components may include brake calipers, throttles, shifter drums, transmission gears, or other component caused to actuate by input by a rider through a user operable interface.

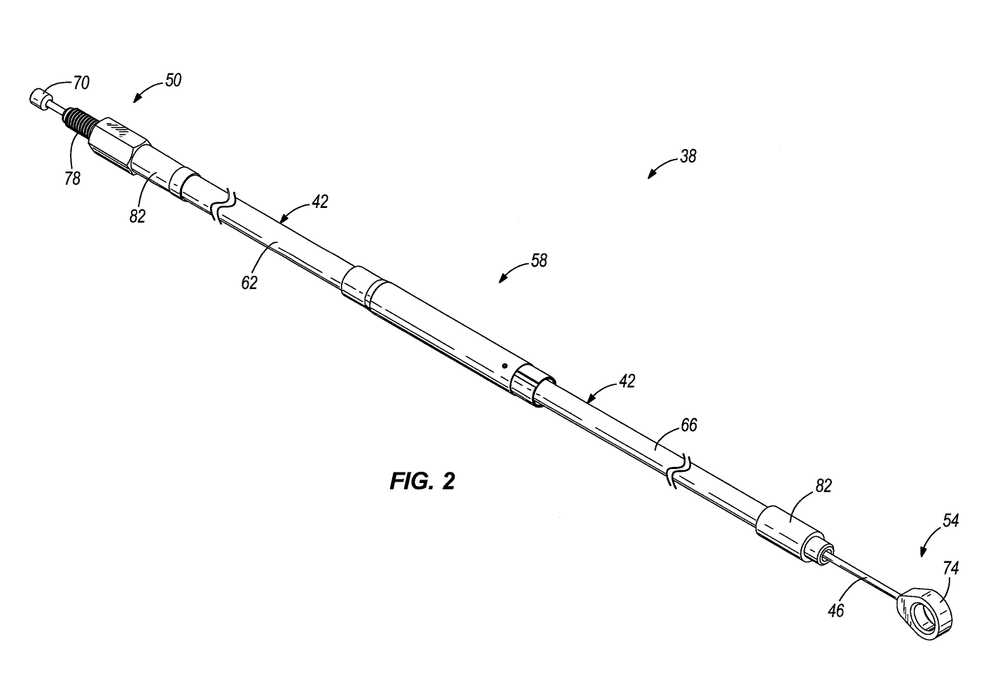

As shown in FIG. 2, the control cable assembly 38 includes a sheathing 42, a cable or wire 46, a first end 50 coupled to the clutch housing 34, a second end 54 coupled to the clutch lever assembly 30, and a control cable adjuster 58. The wire 46 moves within the sheathing 42 in response to the user actuating the clutch lever assembly 30 to actuate the clutch housing 34. Generally, the sheathing 42 is fixed at the first end 50 and the second end 54 such that the wire 46 moves within the relatively stationary sheathing 42. The sheathing 42 provides a low friction surface that allows the wire 46 to move more freely within the sheathing 42. The sheathing 42 may be constructed of coated coiled wire, coated wire strands, or other materials. The illustrated sheathing 42 includes a first section 62 between the first end 50 and the control cable adjuster 58, and a second section 66 between the control cable adjuster 58 and the second end 54.

The illustrated wire 46 is a steel braid coated with a dry lubricant. The wire 46 may be a steel, stainless steel, or composite wire that may be coated with a plastic material, a lubricant, or may be uncoated. The wire 46 includes a first connecting element 70 disposed adjacent the first end 50 for attachment to the clutch lever assembly 30 such that when the clutch lever assembly 30 is actuated, the wire 46 is moved within the sheathing 42. The illustrated wire 46 also includes a second connecting element 74 disposed adjacent the second end 54 for attachment to the clutch such that when the clutch lever assembly 30 is actuated and moves the first connecting element 70, the second connecting element 74 is moved and the clutch is actuated.

The first end 50 includes a threaded connection 78 and a sheathing seat 82. The threaded connection 78 threads into a housing of the clutch lever assembly 30 such that the first end 50 is held in a fixed position with respect to the housing. The sheathing seat 82 receives the sheathing 42 and maintains the sheathing 42 in a fixed position with respect to the threaded connection 78. The wire 46 passes through the first end 50 such that the wire 46 may move within the sheathing 42 and the first end 50 while the sheathing 42 and the first end 50 are substantially stationary.

The second end 54 connects to the clutch housing 34 and includes a sheathing seat 82 that engages the clutch housing 34. In the illustrated embodiment, the clutch housing 34 includes an aperture 86 (see FIG. 1) that receives the sheathing seat 82 such that the wire 46 passes through the second end 54 and the aperture 86. The wire 46 moves within the sheathing 42 in response to the clutch lever assembly 30, and the sheathing 42 is maintained in a stationary position with respect to the clutch housing 34 by the sheathing seat 82 and the aperture 86.

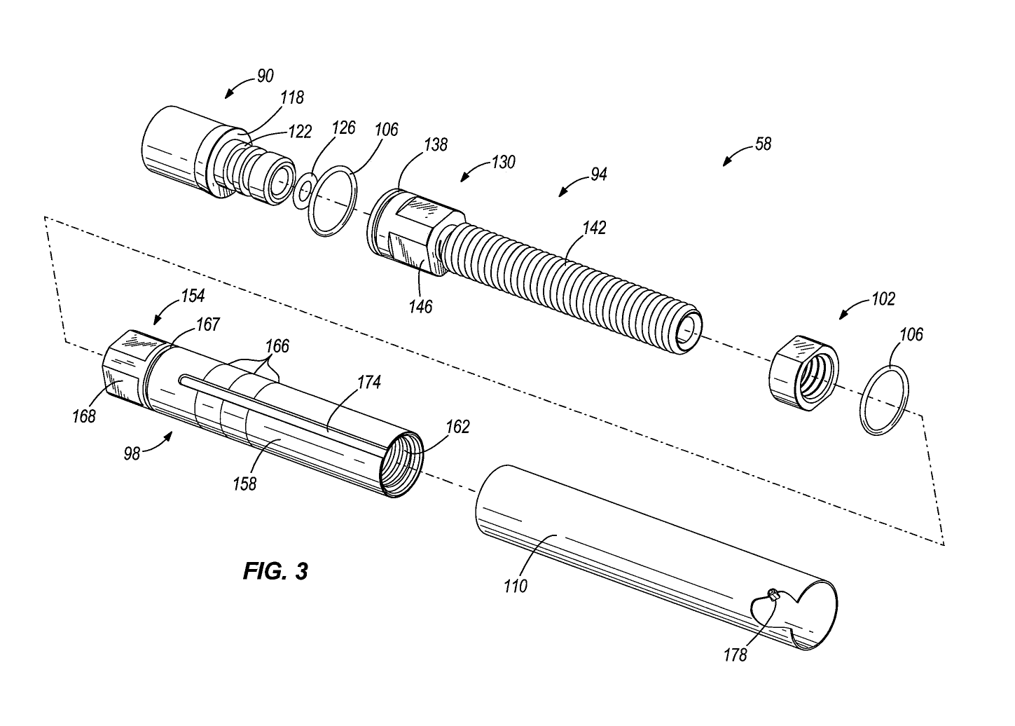

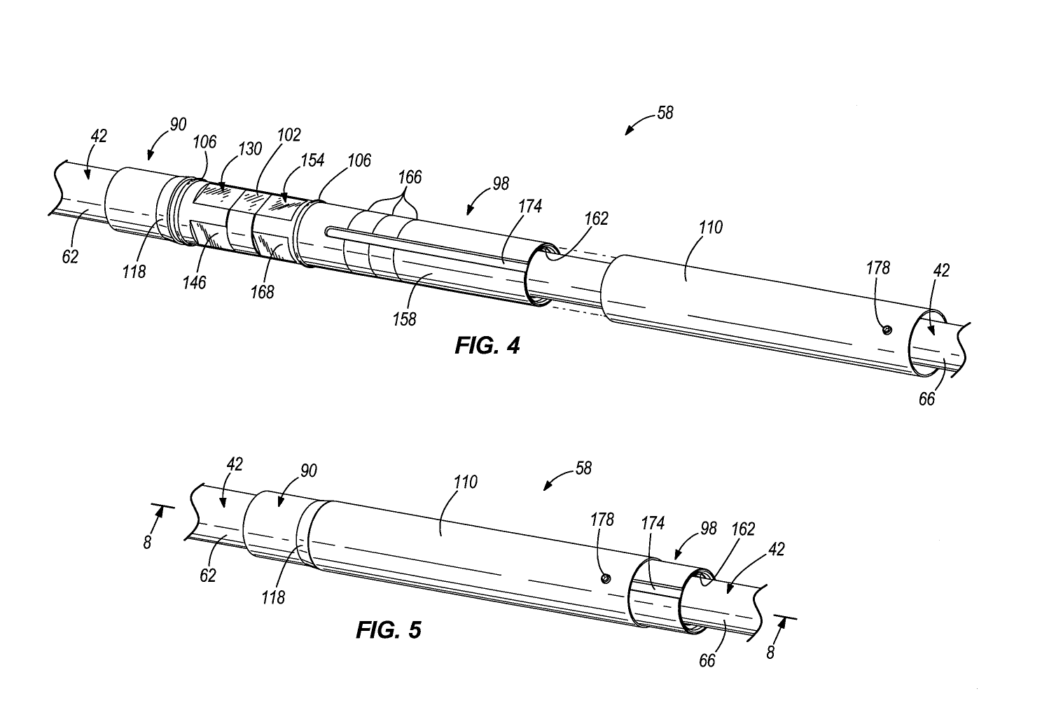

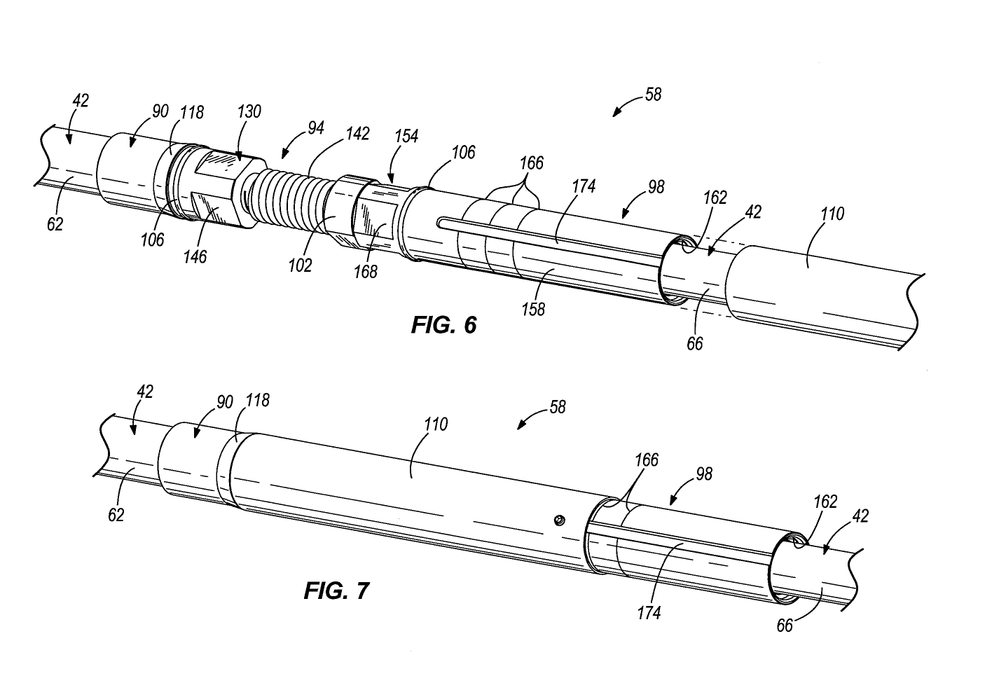

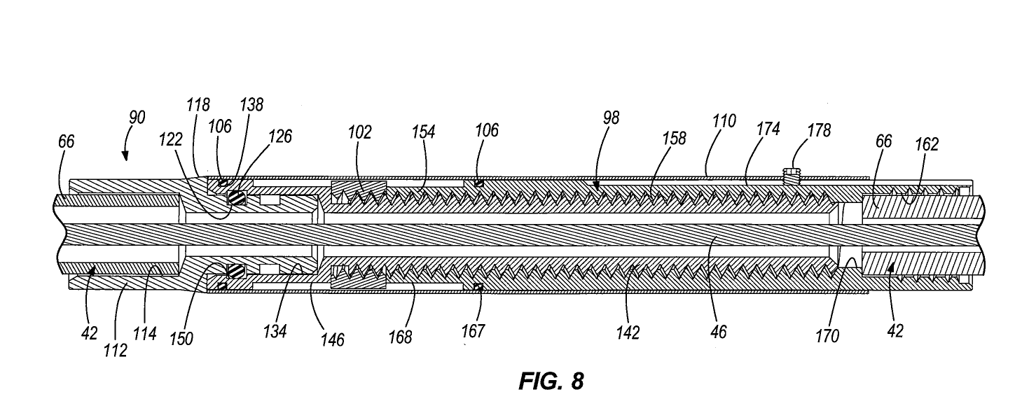

Referring to FIGS. 3 and 8, the control cable adjuster 58 is positioned between the first section 62 and the second section 66 of the sheathing 42 and is movable between various positions between and including a first position (shown in FIGS. 4 and 5) and a second position (shown in FIGS. 6 and 7). By moving the control cable adjuster 58 between the first position and the second position, a user may adjust the overall length of the sheathing such that the control cable assembly 38 may be used on multiple models of vehicles. For example, the control cable assembly 38 may be used as a clutch cable for multiple motorcycle models, including the motorcycle 10. The control cable adjuster 58 also allows a user to tension the wire 46, thereby providing a better response between the clutch lever assembly 30 and the clutch.

The illustrated control cable adjuster 58 includes an end plug 90, a first adjusting element 94, a second adjusting element 98, a locking element 102, two engaging elements 106, and a rigid cover 110. The end plug 90 includes a hollow portion 112 that receives the sheathing 42 and a friction portion 114 that compresses the sheathing 42 to hold the sheathing 42 within the end plug 90 via friction. The end plug 90 also includes a flange 118 that abuts the first adjusting element 94, and a recess 122 that receives an o-ring 126 that holds the end plug 90 and the first adjusting element 94 together and provides a seal in between these two parts.

The first adjusting element 94 includes a first head 130 with a recess 134 that receives a portion of the end plug 90, a first o-ring groove 138, and a first engagement portion 142. The first head 130 also includes first flat portions 146 that may be griped by a tool (e.g., a box end wrench, not shown). The recess 134 includes a groove 150 that receives the o-ring 126 to secure and seal the end plug 90 within the recess 134 (see FIG. 8). The o-ring 126 provides a coupling that may rotate without decoupling the end plug 90 and the first adjusting element 94. In other embodiments, the end plug 90 and first adjusting element 94 may be formed as a single piece.

With continued reference to FIGS. 3 and 8, the first engagement portion 142 is formed as a single piece with the first head 130 and is an elongated tubular member with a first threaded portion (external threads). The wire 46 passes through the first head 130 and the first engagement portion 142.

The illustrated second adjusting element 98 includes a second head 154, a second engagement portion 158, a sheathing recess 162, and an indexing system 166, all formed as a single piece. The second head 154 includes a second o-ring groove 167 and second flat portions 168 that may be gripped by a tool.

The second engagement portion 158 and the second head 154 include a second threaded portion (internal threads, see FIG. 8) that thread onto the first engagement portion 142 such that the first engagement portion 142 is coupled to the second engagement portion 158. Rotation of the first adjusting element 94 with respect to the second adjusting element 98 causes the first engagement portion 142 and second engagement portion 158 to move axially toward or away from one another between the first position and the second position such that a length of the control cable adjuster 58 can be adjusted and is larger at the second position than the first position.

The illustrated sheathing recess 162 is separated from the second engagement portion 158 by a protrusion 170 and is internally threaded to receive the second section 66 of sheathing 42 such that the sheathing 42 is inhibited from moving with respect to the second adjusting element 98.

The indexing system 166 indicates to a user the axial position of the second adjusting element 98 with respect the first adjusting element 94. In the illustrated embodiment, the indexing system 166 includes three lines or marking on an outside surface of the second adjusting element 98. In other embodiments, the indexing system 166 may include more or less markings, or the markings may be disposed on another component. In still other embodiments, the indexing system 166 may be eliminated.

The illustrated locking element 102 comprises a lock nut that threads onto the first engagement portion 142 and can be backed up against the second head 154 of the second adjusting element 98 to lock the second adjusting element 98 in position with respect to the first adjusting element 94. In other embodiments, the locking element 102 may be a set screw, an o-ring, a compression fitting, a snap-ring, or another element that inhibits the axial movement of the second adjusting element 98 with respect to the first adjusting element 94.

The illustrated rigid cover 110 is a metal tubular member that slides between a covered position (FIGS. 2, 5, 7, and 8) where the rigid cover 110 substantially covers the first head 130 and the second head 154, and an exposed position (FIGS. 4 and 6) where the rigid cover 110 substantially exposes the first head 130 and second head 154. As shown in FIG. 8, when the rigid cover 110 is in the covered position, the first adjusting element 94, the locking element 102, and a portion of the second adjusting element 98 are covered, and the rigid cover 110 abuts the flange 118 of the end plug 90. An end of the rigid cover 110 aligns relative to the indexing system 166 of the second adjusting element 98 such that the user may recognize the axial position of the first adjusting element 94 with respect to the second adjusting element 98.

The illustrated engaging elements 106 are seals or o-rings that are received in the o-ring grooves 138, 167 of the first adjusting element 94 and the second adjusting element 98, respectively. The engaging elements 106 engage the rigid cover 110 and hold it in place with respect to the first adjusting element 94 and the second adjusting element 98. The engaging elements 106 also inhibit dirt, water, and/or other contaminates from accessing the first engagement portion 142 and the second engagement portion 158, thereby inhibiting contaminates from fouling the engagement portions 142, 158 and/or being communicated to other components of the motorcycle 10.

The second adjusting element 98 includes a guided element or slot 174 cut longitudinally into the outside surface, and the rigid cover 110 includes a protrusion 178 that engages the slot 174 and slides therein. The slot 174 and protrusion 178 maintain the rigid cover 110 in a fixed alignment or angular position with respect to the second adjusting element 98. In the illustrated embodiment, the protrusion 178 is a set screw that may be tightened against the slot 174 to inhibit the rigid cover 110 from moving with respect to the second adjusting element 98. In other embodiments, the first adjusting element 94 or another element may include the guided element or the protrusion 178. In addition, the protrusion 178 may be eliminated and the guided element may have a different arrangement, as desired. In still other embodiments, the protrusion 178 and the slot 174 may be eliminated.

The control cable adjuster 58 functions to change a total length of the control cable assembly 38 such that the control cable assembly 38 may be used with multiple vehicle arrangements and/or used as a control cable assembly 38 for different components.

The control cable adjuster 58 may be chrome plated, anodized, painted, or treated in another way such that the outward appearance of the control cable adjuster 58 is aesthetically pleasing.

In operation, the illustrated control cable assembly 38 is installed onto the vehicle by attaching the first end 50 to the clutch lever assembly 30 and the second end 54 to the clutch housing 34. The rigid cover 110 is then moved to the exposed position and the locking element 102 is loosened. The control cable adjuster 58 may then be moved between the first position and the second position by rotating the first adjusting element 94 relative to the second adjusting element 98. The tool grips the flat portions 146 of the first adjusting element 94 and another tool grips the flat portions 146 of the second adjusting element 98 such that they are rotated to adjust the length of the control cable adjuster 58 between the first position and the second position until the desired cable tension or cable play is achieved.

When the desired position is achieved, the locking element 102 may be tightened against the second head 154 such that the second adjusting element 98 is inhibited from rotating with respect to the first adjusting element 94 and the length of the control cable adjuster 58 is maintained substantially constant. After the length of the control cable adjuster 58 is positioned as desired, the rigid cover 110 is slid from the exposed position to the covered position such that access to the first engagement portion 142 is inhibited.

If the user desires to adjust the length of the control cable adjuster 58 during normal maintenance, the rigid cover 110 may be moved from the covered position to the exposed position, the locking element 102 loosened, and the first adjusting element 94 rotated with respect to the second adjusting element 98 such that the desired length is achieved.

Various features and advantages of the invention are set forth in the following claims.

What is claimed is:

1. A control cable adjuster comprising:
a first adjusting element with a first engagement portion;
a second adjusting element with a second engagement portion coupled to the first engagement portion, the second adjusting element configured for adjustable axial movement relative to the first adjusting element while maintaining the first and second engagement portions coupled together; and
a rigid cover removably coupled to at least one of the first adjusting element and the second adjusting element, wherein the rigid cover is movable between a covered position where the rigid cover substantially covers a portion of the first engagement portion, and an exposed position where the rigid cover substantially exposes a portion of the first engagement portion.

2. The control cable adjuster of claim 1, wherein the first engagement portion is a first threaded portion and the second engagement portion is a second threaded portion, the first threaded portion threadingly engaged with the second threaded portion, and wherein rotation of the first adjusting element with respect the second adjusting element causes the axial movement of the second adjusting element relative to the first adjusting element.

3. The control cable adjuster of claim 1, further comprising a locking element that locks the first adjusting element in an axial position relative to the second adjusting element.

4. The control cable adjuster of claim 1, further comprising an engaging element coupled to one of the first adjusting element and the second adjusting element, the engaging element configured to inhibit the rigid cover from moving from the covered position to the exposed position.

5. The control cable adjuster of claim 4, wherein the engaging element is an elastic seal that inhibits contaminates from contacting the first engagement portion when the rigid cover is in the covered position.

6. The control cable adjuster of claim 1, further comprising an indexing system on at least one of the first adjusting element, the second adjusting element, and the rigid cover, the indexing system indicating the axial position of the first adjusting element with respect to the second adjusting element.

7. The control cable adjuster of claim 6, wherein the indexing system includes markings on one of the first adjusting element, the second adjusting element, and the rigid cover.

8. The control cable adjuster of claim 1, further comprising a guided element on one of the first adjusting element and the second adjusting element that orients the angular position of the rigid cover with respect to at least one of the first and second adjusting member.

9. The control cable adjuster of claim 1, wherein the rigid cover is a metal tube.

10. A motorcycle comprising:
a user operable interface;
a component associated with the user operable interface; and
a control cable connected between the user operable interface and the component, the control cable including a control cable adjuster having a first adjusting element with a first engagement portion, a second adjusting element with a second engagement portion coupled to the first engagement portion, the second adjusting element configured for adjustable axial movement relative to the first adjusting element while maintaining the first and second engagement portions coupled together, and a rigid cover removably coupled to at least one of the first adjusting element and the second adjusting element, wherein the rigid cover is movable between a covered position where the rigid cover substantially covers a portion the first engagement portion, and an exposed position where the rigid cover substantially exposes a portion of the first engagement portion.

11. The motorcycle of claim 10, wherein the first engagement portion is a first threaded portion and the second engagement portion is a second threaded portion, the first threaded portion threadingly engaged with the second threaded portion, and wherein rotation of the first adjusting element with respect to the second adjusting element causes the axial movement of the second adjusting element relative to the first adjusting element.

12. The motorcycle of claim 10, wherein the control cable adjuster further includes a locking element that locks the first adjusting element in an axial position relative to the second adjusting element.

13. The motorcycle of claim 10, wherein the control cable adjuster further includes an engaging element coupled to one of the first adjusting element and the second adjusting element, the engaging element configured to inhibit the rigid cover from moving from the covered position to the exposed position.

14. The motorcycle of claim 13, wherein the engaging element is an elastic seal that inhibits contaminates from contacting the first engagement portion when the rigid cover is in the covered position.

15. The motorcycle of claim 10, wherein the control cable adjuster further includes an indexing system on at least one of the first adjusting element, the second adjusting element, and the rigid cover, the indexing system indicating the axial position of the first adjusting element with respect to the second adjusting element.

16. The motorcycle of claim 15, wherein the indexing system includes markings on one of the first adjusting element, the second adjusting element, and the rigid cover.

17. The motorcycle of claim 10, wherein the control cable adjuster further includes a guided element on one of the first adjusting element and the second adjusting element that orients the angular position of the rigid cover with respect to at least one of the first and second adjusting member.

18. The motorcycle of claim 10, wherein the rigid cover is a metal tube.

19. A method of adjusting a control cable adjuster, the method comprising:
coupling a first engagement portion of a first adjusting element with a second engagement portion of a second adjusting element;
moving the first adjusting element axially with respect to the second adjusting element;
coupling a rigid cover with at least one of the first adjusting element and the second adjusting element;
substantially covering the first engagement portion with the rigid cover when the rigid cover is in a covered position;
uncoupling the rigid cover from the one of the first adjusting element and the second adjusting element;
moving the rigid cover between the covered position and the exposed position; and
substantially exposing the first engagement portion with the rigid cover when the rigid cover is in an exposed position

20. The method of claim 19, further comprising inhibiting movement of the rigid cover from the covered position to the exposed position with an elastic seal disposed between the rigid cover and one of the first adjustment element and the second adjustment element.
